(19) United States
(12) Patent Application Publication
(10) Pub. No.: US 2019/0265881 A1
(43) Pub. Date: Aug. 29, 2019

(54) INFORMATION PROCESSING APPARATUS, INFORMATION PROCESSING METHOD, AND STORAGE MEDIUM

(71) Applicant: SHARP KABUSHIKI KAISHA, Osaka (JP)

(72) Inventors: KEIKO HIRUKAWA, Sakai City (JP); AMI HADA, Sakai City (JP)

(21) Appl. No.: 16/289,472

(22) Filed: Feb. 28, 2019

(30) Foreign Application Priority Data
Feb. 28, 2018 (JP) 2018-034391

(51) Int. Cl. G06F 3/0488; G10L 15/26; G06F 17/21; G06F 3/16

(52) U.S. Cl. CPC G06F 3/04883; G06F 3/167; G06F 17/212; G10L 15/265

(57) ABSTRACT

An information processing apparatus includes a display processing unit that causes a display unit to display information based on a touch operation by a user to a touch panel, and in a case where predetermined first input information and predetermined second input information that are set in advance are input by the touch operation of the user, the display processing unit causes text information converted from voice data to be displayed on the display unit in a region between a position of the first input information and a position of the second input information.

### BACKGROUND

### 1. Field

The present disclosure relates to an information processing apparatus, an information processing method, and a storage medium storing a program that cause a display unit to display information according to an input operation by a user to a touch panel.

### 2. Description of the Related Art

A technique of converting input voice data into text data and causing an electronic blackboard to display text information (such as a character string) corresponding to the text data has been proposed.

For example, International Publication No. WO2016/189735 discloses an input display device that displays, on a display unit, a track image of a line drawn with touch drawing on a touch panel and causes a character string indicating a voice recognition result to be superimposed and displayed on the track image.

Moreover, for example, Japanese Unexamined Patent Application Publication No. 2002-251280 discloses an electronic blackboard device that displays a recognition result, which is obtained by a voice recognition unit, in a region including a drawn track, which is drawn with a pen during voice input period, in an electronic blackboard.

In the related art described above, however, in a case where the display unit is caused to display the text data corresponding to the voice data, a user is requested, during voice input, to perform an input operation all the time at a position where the text information is displayed on the touch panel. Therefore, for example, while the text information is di played on the display unit, it is difficult for the user to perform a general handwriting operation (handwriting input) in the electronic blackboard (touch panel). In this manner, the related art described above causes a problem of deterioration in convenience of the user.

The disclosure provides an information processing apparatus, an information processing method, and a storage medium storing a program capable of improving convenience of a user in the information processing apparatus that causes a display unit to display information according to an input operation by a user to a touch panel.

### SUMMARY

An information processing apparatus according to an aspect of the disclosure includes a display processing unit that causes a display unit to display information based on a touch operation by a user to a touch panel, and in a case where predetermined first input information and predetermined second input information that are set in advance are input by the touch operation of the user, the display processing unit causes predetermined information to be displayed on the display unit in in a region between a position of the first input information and a position of the second input information.

An information processing method according to another aspect of the disclosure includes: causing a display unit to display information based on a touch operation by a user to a touch panel; and in a case where predetermined first input information and predetermined second input information that are set in advance are input by the touch operation of the user, causing predetermined information to be displayed on the display unit in a region between a position of the first input information and a position of the second input information.

A non-transitory storage medium according to another aspect of the disclosure is a non-transitory storage medium storing a program causing a computer to execute: causing a display unit to display information based on a touch operation by a user to a touch panel; and in a case where predetermined first input information and predetermined second input information that are set in advance are input by the touch operation of the user, causing predetermined information to be displayed on the display unit in a region between a position of the first input information and a position of the second input information.

### BRIEF DESCRIPTION OF THE DRAWINGS

FIG. 1 is a block diagram illustrating a schematic configuration of an information processing system according to Embodiment 1 of the disclosure;

FIG. 2 illustrates an example of a display screen displayed on a display unit according to Embodiment 1 of the disclosure;

FIG. 3 illustrates an example of a display screen displayed on the display unit according to Embodiment 1 of the disclosure;

FIG. 4 illustrates an example of a display screen displayed on the display unit according to Embodiment 1 of the disclosure;

FIG. 5 illustrates an example of a display screen displayed on the display unit according to Embodiment 1 of the disclosure;

FIG. 6 is a flowchart for explaining an example of procedure of text information display processing in an information processing apparatus according to Embodiment 1 of the disclosure;

FIG. 7 is a flowchart for explaining an example of procedure of voice conversion processing in the information processing apparatus according to Embodiment 1 of the disclosure;

FIG. 8 illustrates an example of a display screen displayed on the display unit according to Embodiment 1 of the disclosure;

FIG. 9 illustrates an example of a display screen displayed on the display unit according to Embodiment 1 of the disclosure;

FIG. 10 is a flowchart for explaining an example of procedure of voice conversion processing in an information processing apparatus according to Embodiment 2 of the disclosure;

FIG. 11 is a flowchart for explaining an example of procedure of voice conversion processing in an information processing apparatus according to Embodiment 3 of the disclosure;

FIG. 12 illustrates an example of a display screen. displayed on a display unit according to Embodiment 3 of the disclosure;

FIG. 13 is a flowchart for explaining an example of procedure of voice conversion processing in an information processing apparatus according to Embodiment 4 of the disclosure;

FIG. 14 illustrates an example of a display screen displayed on a display unit according to Embodiment 5 of the disclosure; and

FIG. 15 illustrates an example of a display screen displayed on a display unit according to Embodiment 6 of the disclosure.

### DESCRIPTION OF THE EMBODIMENTS

Embodiments of the disclosure will be described below with reference to accompanying drawings. Note that, the following embodiments are examples of specific embodiments of the disclosure and do not limit the technical scope of the disclosure.

An information processing system according to the disclosure is applicable, for example, to a system (electronic blackboard system) that includes an electronic blackboard.

### Embodiment 1

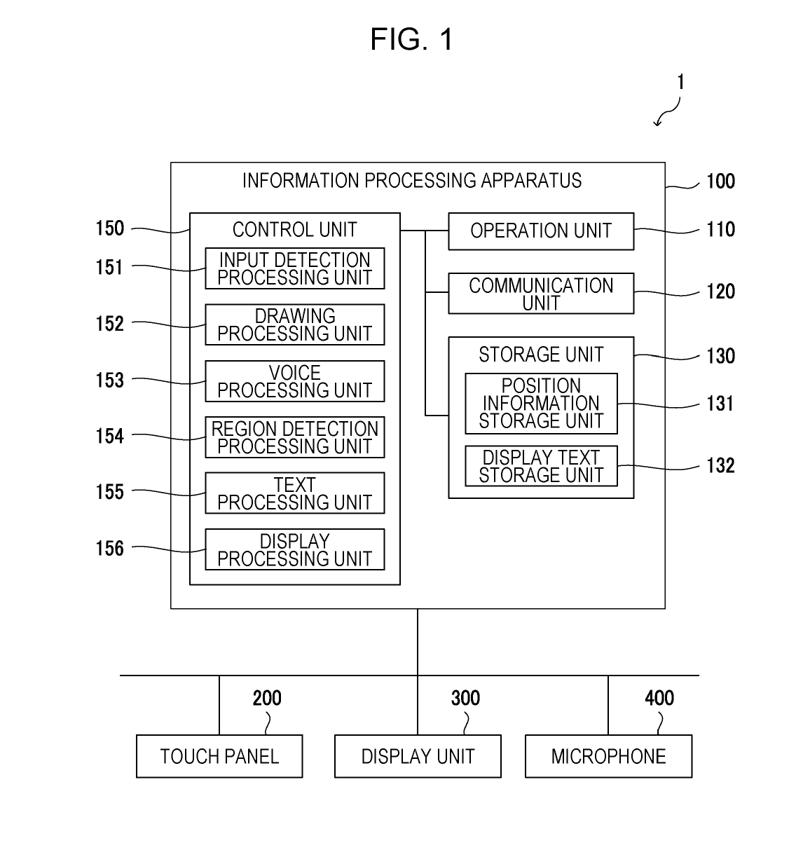

FIG. 1 is a block diagram illustrating a schematic configuration of an information processing system 1 according to Embodiment 1.

The information processing system 1 includes an information processing apparatus 100, a touch panel 200, a display unit 300, and a microphone 400. The touch panel 200, the display unit 300, and the microphone 400 are connected to the information processing apparatus 100 through a network. The network is a communication network such as a wired LAN or a wireless LAN. The touch panel 200 and the display unit 300 may be in formed. For example, the touch panel 200, the display unit 300, and. microphone 400 are connected to the information processing apparatus 100 through various cables such as a USB cable. The information processing apparatus 100 may be a PC (personal computer) connected to the display unit 300, a controller mounted inside a display apparatus, or a server (or cloud server) connected through the network. The information processing apparatus 100 may perform voice recognition processing (described below) inside the information processing apparatus 100 or perform the voice recognition processing in the server.

The touch panel 200 is a general-purpose touch panel and is able to use any type such as an electrostatic capacitive type, an electromagnetic induction type, a resistance film type, or an infrared type. The display unit 300 is a general-purpose display panel and is able to use any display panel such as a liquid crystal panel or an organic EL panel. In the information processing system 1 according to the present embodiment, for example, the touch panel 200 of the electrostatic capacitive type is provided on a display surface of the display unit 300 that is a liquid crystal panel.

Here, an example of an outline of the information processing system 1 according to the embodiment of the disclosure will be indicated below. Here, it is assumed that the information processing system 1 is introduced in an electronic blackboard system in a conference room.

For example, when performing presentation of a material at a conference, a user causes the display unit 300 to display the material and explains while performing handwriting input on the touch panel 200. In this case, the information processing system 1 converts voice corresponding to explanation (statement) of the user into text information TX (character string) and causes the text information TX to be displayed on the display unit 300.

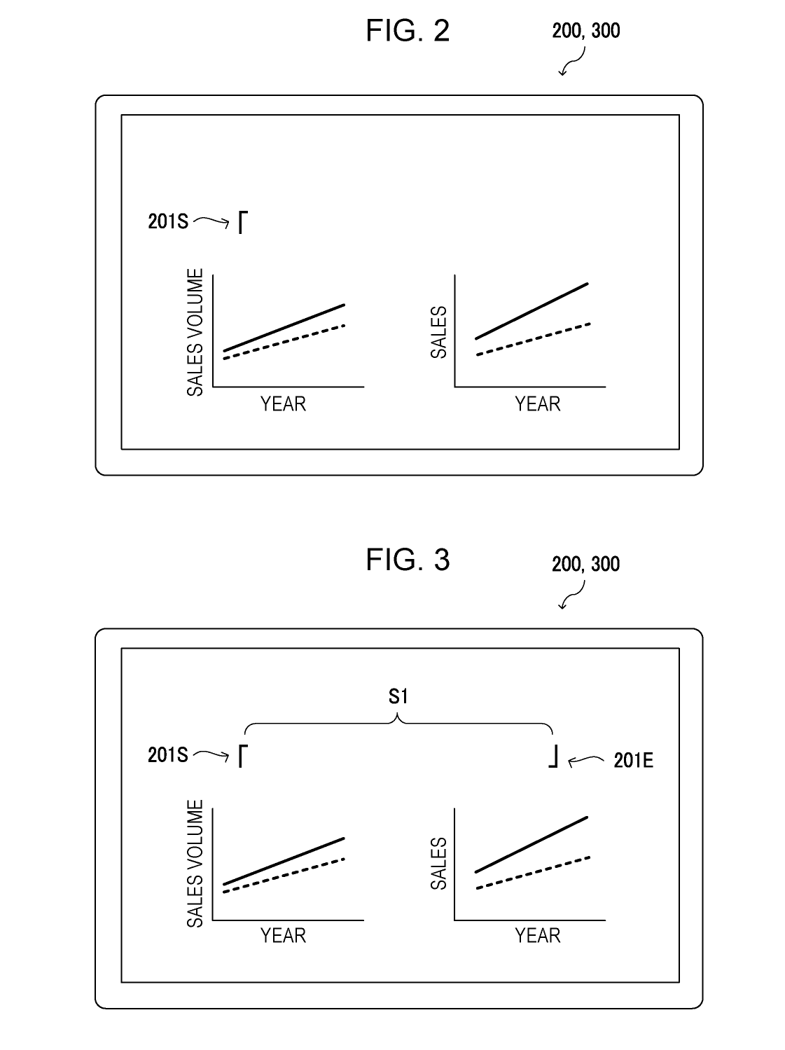

Specifically, the voice corresponding to the explanation. (statement) of the user is sequentially converted into text information TX. Next, in the middle of the explanation, the user inputs first input information 201S (here, mark of “┌” (left bracket)) by handwriting at any position on the touch panel 200 as illustrated in FIG. 2.

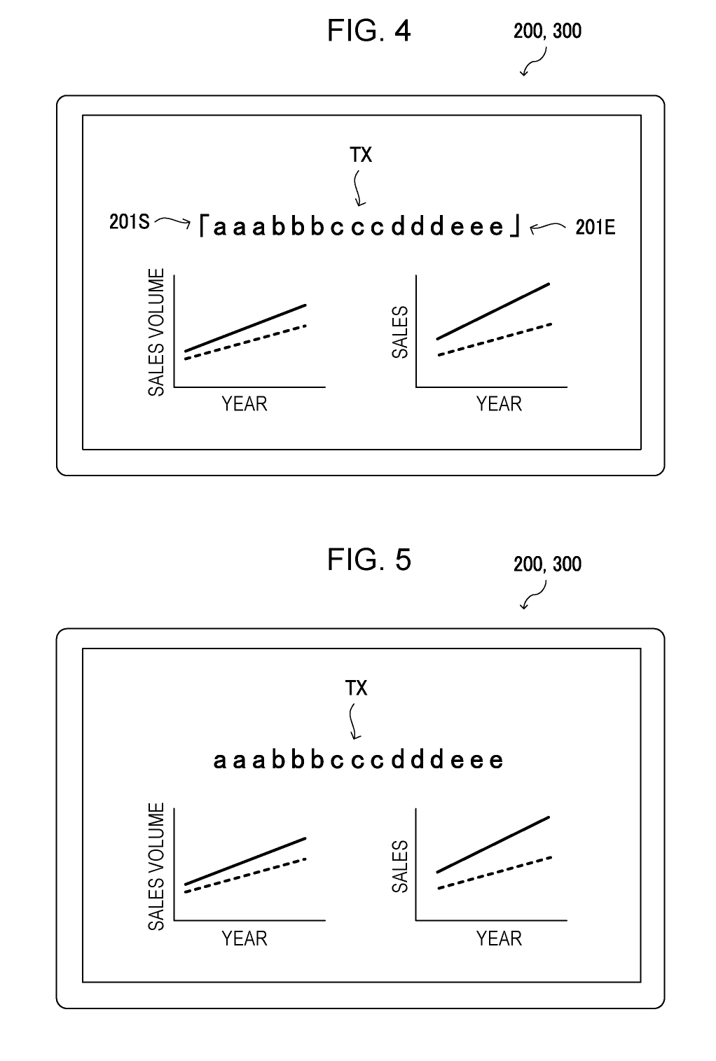

Subsequently, as illustrated in FIG. 3, the user inputs second input information 201E (here, mark of “┘” (right bracket)) by handwriting at any position on the touch panel 200. Then, text information TX (here, assumed to be ┌aaabbbcccdddeee┘) corresponding to voice uttered by the user during a period from when the first input information 201S is input (detected) until the second input information 201E is input (detected) is stored in a storage unit. Moreover, the text information TX stored in the storage unit is displayed in a region S1 (refer to FIG. 3) from a position of the first input information 201S to a position of the second input information 201E (refer to FIG. 4). Note chat, the text information TX is displayed, for example, with a size of a character adjusted to a size corresponding to the region S1.

Finally, as illustrated in FIG. 5, the first input information 201S and the second input information 201E are deleted from the display unit 300. In this manner, the text information TX (character string) corresponding to the voice of the user is displayed on the display unit 300.

A specific configuration of the information processing apparatus 100 to implement the processing illustrated in FIGS. 2 to 5 described above will be described below.

### Configuration of Information Processing Apparatus 100

As illustrated in FIG. 1, the information processing apparatus 100 includes an operation unit 110, a communication unit 120, a storage unit 130, and a control unit 150.

The operation unit 110 is a device (user interface) used when a user performs a predetermined operation and an example thereof includes a keyboard or a mouse.

The communication unit 120 is a communication interface that connects the information processing apparatus 100 to the network to execute data communication according to a predetermined communication protocol with an external device, such as the touch panel 200, the display unit 300, or the microphone 400, through the network.

The storage unit 130 is a non-volatile storage unit such as a hard disc or an EEPROM. In the storage unit 130, various kinds of control programs executed by the control unit 150, various kinds of data, and the like are stored.

The storage unit 130 includes a position information storage unit 131 and a display text storage unit 132. In the position information storage unit 131, information (input position information) of a position that is touched (position where an input instruction is given) on the touch panel 200 by the user is stored. In the display text storage unit 132, text data corresponding to text information TX, such as a character string, to be displayed on the display unit 300 is stored. The text data is data obtained by converting voice data input to the information processing apparatus 100 into a text format (such as a character string).

The control unit 150 includes control devices such as a CPU, a ROM, and a RAM. The CPU is a processor that executes various kinds of arithmetic processing. The ROM is a non-volatile storage unit in which information of, for example, a control program causing the CPU to execute various kinds of processing is stored in advance. The RAM is a volatile or non-volatile storage unit that is used as a temporary storage memory (working area) for various kinds of processing executed by the CPU. The control unit 150 controls the information processing apparatus 100 by causing the CPU to execute various kinds of control programs stored in the ROM or the storage unit 130 in advance.

Specifically, the control unit 150 includes processing units such as an input detection processing unit 151, a drawing processing unit 152, a voice processing unit 153, a region detection processing unit 154, a text processing unit 155, and a display processing unit 156. Note that, the control unit 150 executes various kinds of processing in accordance with the control programs to thereby function as the respective processing units. The co unit 150 may include an electronic circuit that implements one or more processing functions of the processing units.

The input detection processing unit 151 detects information input by the user to the touch panel 200. Specifically, in a case where the user performs a predetermined input operation (touch operation) to the touch panel 200, the input detection processing unit 151 acquires, through the communication unit 120, input information (touch information) according to the input operation. In a case where the user performs the predetermined input operation by using the operation unit 110, the input detection processing unit 151 detects input information according to the input operation.

For example, in a case where the user touches any position on the touch panel 200, the input detection processing unit 151 detects the touch input. The input detection processing unit 151 also detects information (input position information) of a position (touched position) touched on the touch panel 200 by the user. In a case where the user performs a handwriting operation at any position on the touch panel 200, the input detection processing unit 151 detects input information (such as a handwritten character) according to the handwriting operation. The input information includes a character, a graphic, a mark, or the like. The input information also includes the first input information 201S (for example, “┌”) (refer to FIG. 2) and the second input information 201E (for example, “┘”) (refer to FIG. 3) that are predetermined input information set in advance.

The input detection processing unit 151 detects the information (input position information) of the touched position and stores the information in the position information storage unit 131. For example, in a case where the user inputs the first input information 201S (“┌”) (refer to FIG. 2) by handwriting on the touch panel 200, the input detection processing unit 151 detects information (first input position information) of an input position of the first input information 201S (“┌”) and stores the information in the position information storage unit 131. In a case where the user inputs the second input information 201E (“┘”) (refer to FIG. 3) by handwriting on the touch panel 200, the input detection processing unit 151 detects information (second input position information) of an input position of the second input information 201E (“┘”) and stores the information in the position information storage unit 131.

The drawing processing unit 152 draws the input information detected by the input detection processing unit 151. Specifically, the drawing processing unit 152 draws handwritten information (such as a character or a graphic) by the user to the touch panel 200. For example, the drawing processing unit 152 draws the first input information 201S (“┌”) and the second input information 201E

The display processing unit 156 causes the display unit 300 to display the input information, which is drawn by the drawing processing unit 152, on the basis of the input position information detected by the input detection processing unit 151.

The voice processing unit 153 acquires voice of the user through the microphone 400 and converts acquired voice data into text data. The voice processing unit 153 stores the text data in the display text storage unit 132. For example, the voice processing unit 153 stores, in the display text storage unit 132, text data obtained by converting the voice into the text information during a period from when the first input information 201S is detected until the second input information 201S is detected.

On the basis of the position information (first input position information) of the first input information 201S and the position information (second input position information ) of the second input information 201E that are stored in the position information storage unit 131, the region detection processing unit 154 detects a region S1 (refer to FIG. 3) between a position of the first input information 201S and a position of the second input information 201E.

The text processing unit 155 executes processing of adjusting (deciding) a display form of the text information TX to be displayed in the region S1 to a display form corresponding to the region S1. For example, the text processing unit 155 adjusts a size of a character that is the text information TX to a size corresponding to the region S1. The text processing unit 155 deletes, from the display text storage unit 132, the text data stored in the display text storage unit 132.

The display processing unit 156 causes the text information TX, the display form of which is adjusted by the text processing unit 155, to be displayed on the display unit 300 in the region S1 detected by the region detection processing unit 154. The display processing unit 156 deletes the first input information 201S and the second input information 201E from the display unit 300 (refer to FIG. 5). Note that, the display processing unit 156 also causes the di pi v unit 300 to display information input from the touch panel 200 and information input through the operation unit 110.

In this manner, the predetermined input information (for example, the first input information 201S and the second input information 201E) serves as trigger information to convert voice data into text data and cause the display unit 300 to display text information corresponding to the text data.

### Text Information Display Processing

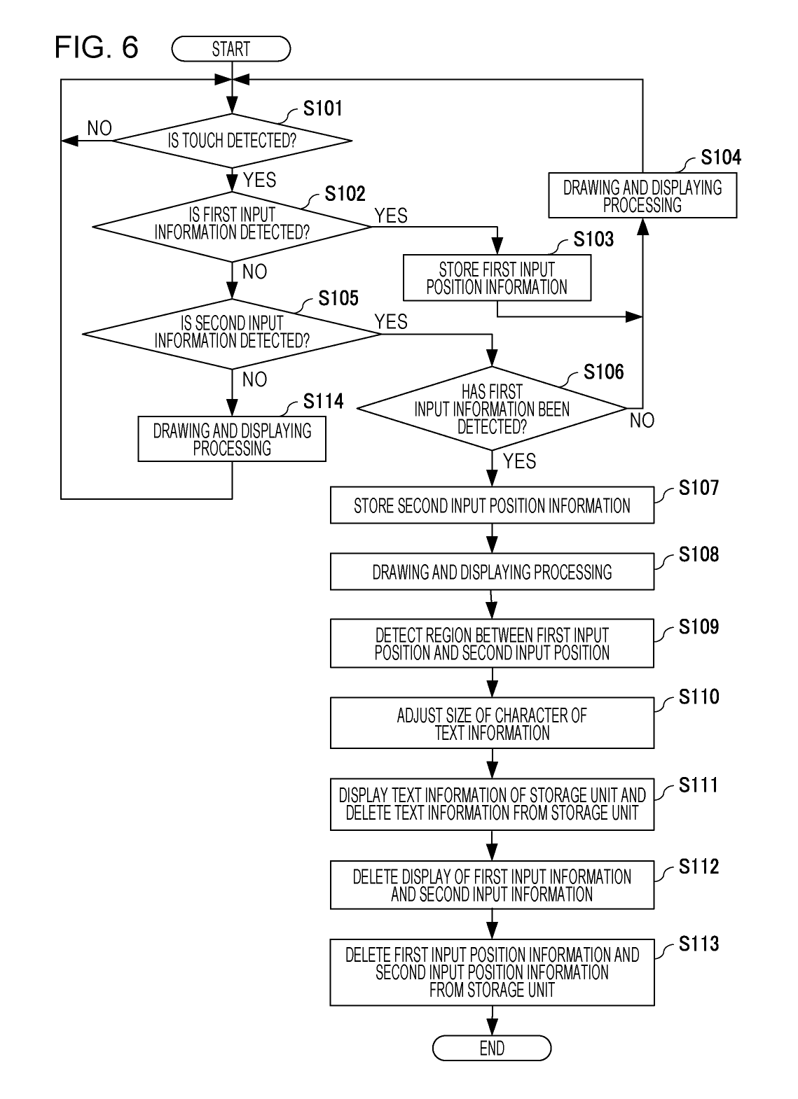

An example of text information display processing executed by the control unit 150 of the information processing apparatus 100 will be described below with reference to FIG. 6. Here, description will be given on the basis of the examples illustrated in FIGS. 2 to 5. Note that, the text information display processing is ended halfway in accordance with a predetermined operation by the user in the information processing apparatus 100 in some cases.

### Step S101

First, at step S101, the input detection processing unit 151 determines whether or not the user touches any position on the touch panel 200. When the user touches any position on the touch panel 200 (S101: YES), the input detection processing unit 151 detects the touch input and the procedure shifts to step S102.

### Step S102

At step S102, the input detection processing unit 151 determines whether or not the user inputs the first input information 201S (for example, “┌”) at any position on the touch panel 200. When the user inputs the first input information 201S at any position on the touch panel 200, the input detection processing unit 151 detects the first input information 201S (S102: YES) and the procedure shifts to step S103. When the input detection processing unit 151 does not detect the first input information 201S (S102: NO), the procedure shifts to step S105.

### Step S103

At step S103, the input detection processing unit 151 stores, in the position information storage unit 131, information (first input position information) of an input position of the first input information 201S.

### Step S104

At step S104, the drawing processing unit 152 draws the first input information 201S. The display processing unit 156 causes the display unit 300 to display the first input information 201S, which is drawn by the drawing processing unit 152, on the basis of the first input position information (refer to FIG. 2). After that, the procedure returns to step S101.

Subsequently, when the user touches any position on the touch panel 200 at step S101, the input detection processing unit 151 detects the touch input and the procedure shifts to step S102. When the input detection processing unit 151 does not detect the first input information 201S at step S102 (S102: NO), the procedure shifts to step S105.

### Step S105

At step S105, the input detection processing unit 151 determines whether or not the user inputs the second input information 201E at any position on the touch panel 200. When the user inputs the second input information 201E at any position on the touch panel 200 (S105: YES), the input detection processing unit 151 detects the second input information 201E and the procedure shifts to step S106. When the input detection processing unit 151 does not detect the second input information 201E (S105: NO), the procedure shifts to step S114. Here, it is assumed that the user inputs the second input information 201E (for example, (“┘”).

### Step S106

At step S106, the input detection processing unit 151 determines whether or not the first input information 201S has been detected, and when the first input information 201S has been detected (S106: YES), the procedure shifts to step S107, and when the first input information 201S has not been detected (S106: NO), the procedure returns to step S104. At step S104 in this case, the drawing processing unit 152 draws various kinds of input information according to a handwriting operation by the user to the touch panel 200 and the display processing unit 156 causes the display unit 300 to display the input information. Here, since the input detection processing unit 151 has detected the first input information 201S, the procedure shifts to step S107.

### Step S107

At step S107, the input detection processing unit 151 stores, in the position information storage unit 131, information (second input position information) of an input position of the second input information 201E.

### Step S106

At step S108, the drawing processing unit 152 draws the second input information 201E. The display processing unit 156 causes the display unit 300 to display the second input information 201E, which is drawn by the drawing processing unit 152, on the basis of the second input position information (refer to FIG. 3).

### Step S109

At step S109, the region detection processing unit 154 detects the region S1 between a position of the first input information 201S and a position of the second input information 201E on the basis of the first input position information and the second input position information that are stored in the position information storage unit 131 (refer to FIG. 3).

### Step S110

At step S110, the text processing unit 155 acquires text information TX (refer to [Voice conversion processing] described below) corresponding to text data stored in the display text storage unit 132 and adjusts a size of a character of the text information TX to a size corresponding to the region S1.

### Step S111

At step S111, the display processing unit 156 causes the text information TX, in which the size of the character is adjusted by the text processing unit 155 to the size corresponding to the region S1 to be displayed on the display unit 300 in the region S1 detected by the region detection processing unit 154 (refer to FIG. 4). The text processing unit 155 deletes, from the display text storage unit 132, the text data stored in the display text storage unit 132.

### Step S112

At step S112, the display processing unit 156 deletes the first input information 201S and the second input information 201E from the display unit 300 (refer to FIG. 5).

### Step S113

At step S113, the input detection processing unit 151 deletes the first input post ion information and the second input position information from the position information storage unit 131.

### Step S114

At step S114, since the first input information 201S (“┌”) and the second input information 201E (“┘”) are not detected, drawing processing and displaying processing for information (such as a handwritten character) input on the touch panel 200 by handwritten by the user are executed. As described above, the text information display processing is executed.

### Voice Conversion Processing

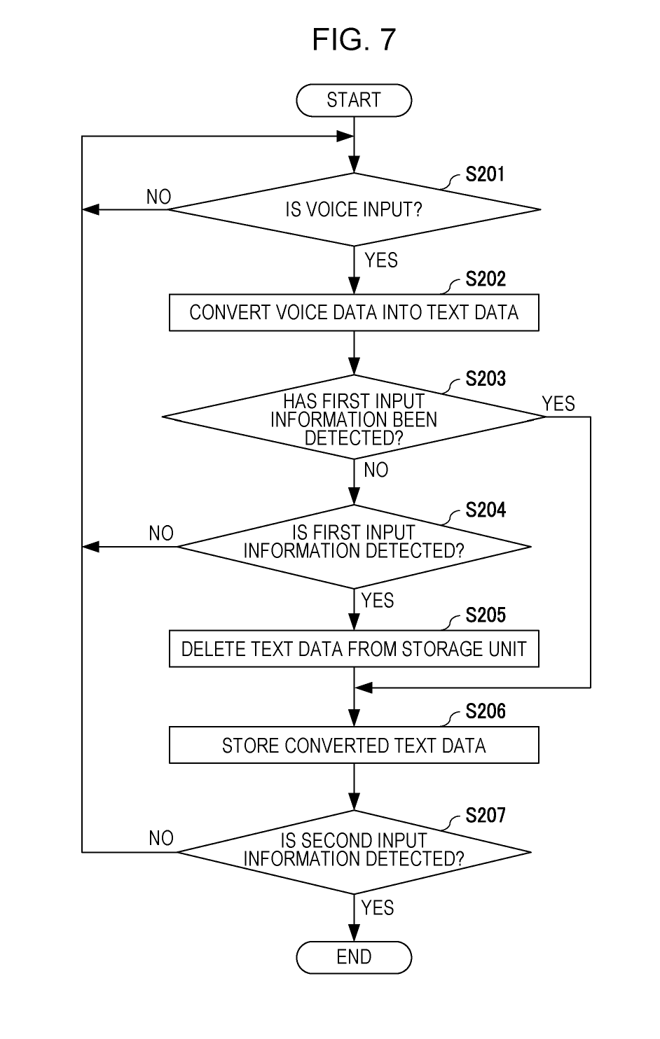

An example of voice conversion processing executed by the control unit 150 of the information processing apparatus 100 will be described below with reference to FIG. 7. Here, description will be also given on the basis of the examples illustrated in FIGS. 2 to 5. Note that, the voice conversion processing is ended halfway in accordance with a predetermined operation by the user in the information processing apparatus 100 in some cases. Moreover, the text. information display processing (refer to FIG. 6) and the voice conversion processing (refer to FIG. 7) are executed. in parallel.

### Step S201

At step S201, when voice of the user is input to the information processing apparatus 100 through the microphone 400 (S201: YES), the voice processing unit 153 acquires data of the voice through the microphone 400.

### Step S202

At step S202, the voice processing unit 153 converts the acquired voice data into text data.

### Step S203

When the input detection processing unit 151 has already detected the first input information 201S at step S203 (S203: YES), the procedure shifts to step S206. When the input detection processing unit 151 has not detected the first input information 201S (S203: NO), the procedure shifts to step S204.

### Step S204

When the input detection processing unit 151 detects the first input information 201S at step S204 (S204: YES), the procedure shifts to step S205. When the input detection processing unit 151 does not detect the first input information 201S (S204: NO), the procedure returns to step S201.

### Step S205

At step S205, the text data stored in the display text storage unit 132 is deleted from the display text storage unit 132. Thereby, the display text storage unit 132 is reset.

### Step S206

At step S206, the voice processing unit 153 stores the converted text data in the display text storage unit 132. That is, when the first input information 201S is detected, text information corresponding to the voice of the user is sequentially stored in the display text storage unit 132.

### Step S207

When the input detection processing unit 151 detects the second input information 201E at step S207 (S207: YES), the processing ends. When the input detection processing unit 151 does not detect the second input information 201E (S207: NO), the procedure returns to step S201.

When the voice of the user is continuously input to the information processing apparatus 100 after the procedure returns to step S201 (S201: YES), it is determined that the input detection processing unit 151 has already detected the first input information 201S at step S203 (S203: YES), and the procedure shifts to step S206. The voice processing unit 153 continuously stores the converted text data in the display text storage unit 132. As a result, text information corresponding to the voice of the user is stored in the display text storage unit 132 until the second input information 201E is detected (input).

As described above, the voice conversion processing is executed. The voice processing unit 153 stores, in the display text storage unit 132, the text data converted from the voice data during a period from when the first input information 201S is detected until the second input information 201E is detected. Note that, the text data stored in the display text storage unit 132 is displayed on the display unit 300 in accordance with an operation by the user (refer to [Text information display processing] described above).

As described above, in the information processing apparatus 100 according to Embodiment 1, when the user touches and inputs, on the touch panel 200, the predetermined first input information 201S (for example, “┌”) serving as a start point (trigger information) and the predetermined second input information 201E (for example, “┘”) serving as an end point, text information (character string) obtained by converting the voice into the text is displayed in a range (region S1) between the first input information 201S and the second input information 201E. According to such a configuration, when the display unit 300 is caused to display the text information TX for the voice, the user may not operate the touch panel 200 all the time and may perform only touch input (input operation) at two places. That is, the display processing unit 156 is able to perform first display processing of causing the display unit 300 to display the text information TX corresponding to the text data converted from the voice data and second display processing of causing the display unit 300 to display handwritten information by the user to the touch panel 200, in parallel. Accordingly, the user is able to perform a touch input operation on the touch panel 200 while causing the display unit 300 to display the text information TX corresponding to the voice. Thus, it is possible to improve convenience of the user.

In the processing described above, the text information TX obtained by converting the voice into a text format is configured to be displayed on the display unit 300 after the user inputs the second input information 201E (for example, “┘”) on the touch panel 200, but timing when the text information TX is di played on the display unite 300 is not limited to the configuration described above. For example, the text information TX may be displayed on the display unit 300 after the first input information 201S (for example, “┌”) is input on the touch panel 200 by the user and before the second input information 201E (for example, “┘”) is input on the touch panel 200 by the user. An outline of such a configuration will be indicated below.

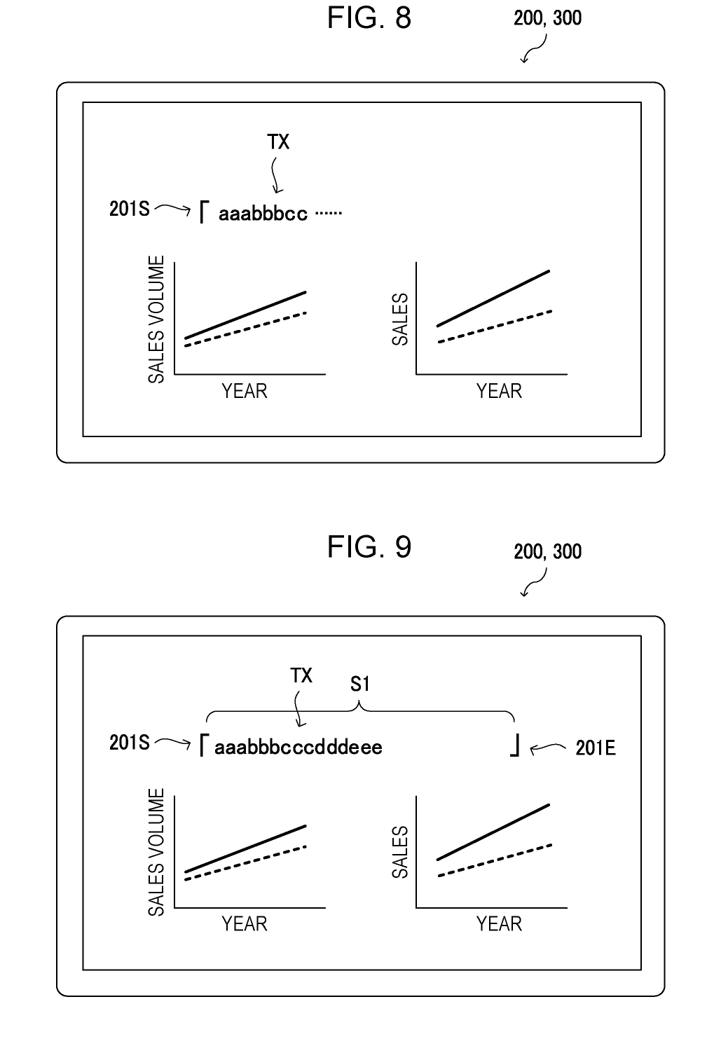

First, as illustrated in FIG. 2, the user inputs the first input information 201S (for example, “┌”) by, handwriting at any position on the touch panel 200. Then, as illustrated in FIG. 8, the voice of the user is converted into text information TX and the text information TX is displayed at a position of the first input information 201S (horizontally) on the display unit 300. Note that, the text information TX is displayed on the display unit 300 by following (in conjunction with) a statement of the user.

Next, as illustrated in FIG. 9, the user inputs the second input information 201E (for example, “540 ”) by, handwriting at any position on the touch panel 200. Then, display processing of the text information TX is stopped, and the text information TX corresponding to the voice uttered by the user during a period from when the first input information 201S is input (detected) until the second input information 201E is input (detected) is displayed in the region S1 from the position of the first input information 201S to the position of the second input information 201E.

Further, as illustrated in FIG. 4, a size of a character of the text information TX displayed in the region S1 is changed to a size corresponding to the region S1. Finally, as illustrated in FIG. 5, the first input information 201S and the second input information 201S are deleted from the display unit 300. Thereby, the text information TX (character string) corresponding to the voice of the user is displayed on the display unit 300.

An information processing system 1 according to another embodiment will be described below. Not that, a component having the same function as that of the information processing system 1 according to Embodiment 1 will be given the same name and description thereof will be omitted as appropriate.

### Embodiment 2

In an information processing system 1 according to Embodiment 2, in a case where the input detection processing unit 151 detects the first input information 201S (for example, “┌”), the voice conversion processing (refer to FIG. 7) is executed.

Specifically, in a case where the input detection processing unit 151 detects the first input information 201S, the voice processing unit 153 starts voice input processing, and when the input detection processing unit 151 detects the second input information 201E, the voice processing unit 153 ends the voice input processing. Upon start of the voice input processing, the voice processing unit 153 converts voice data into text data. That is, the voice processing unit 153 converts the voice data into the text data only during a period from when the first input information 201S is detected until the second input information 201E is detected. The voice processing unit 153 stores the text data in the display text storage unit 132.

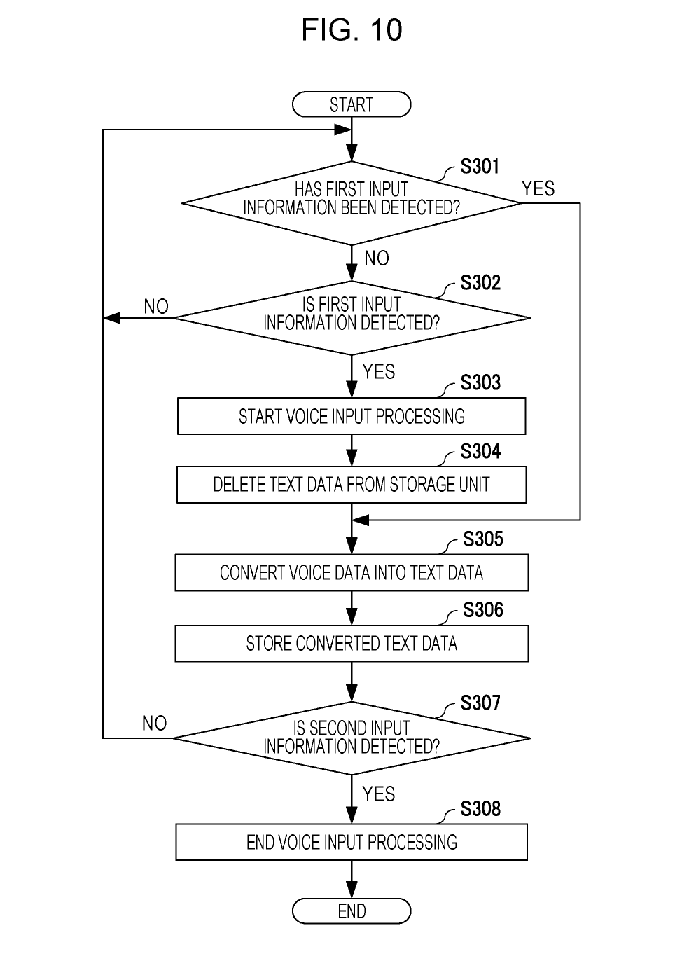

An example of voice conversion processing according to Embodiment 2 will be described below with reference to FIG. 10.

### Step S301

When the input detection processing unit 151 has already detected the first input information 201S at step S301 (S301: YES), the procedure shifts to step S305. the input detection processing unit 151 has not detected the first input information 201S (S301: NO), the procedure shifts to step S302.

### Step S302

When the input detection processing unit 151 detects the first input information 201S at step S302 (S302: YES), the procedure shifts to step S303 and the voice processing unit 153 start voice input processing. When the voice input processing starts, voice of the user is input to the information processing apparatus 100 through the microphone 400, and the voice processing unit 153 acquires data of the voice through the microphone 400. When the input detection processing unit 151 does not detect the first input information 201S (S302: NO), the procedure returns to step S301.

### Step S304

At step S304, the text data stored in the display text storage unit 132 is deleted from the display text storage unit 132. Thereby, the display text storage unit 132 is reset.

### Step S305

At step S305, the voice processing unit 153 converts the acquired voice data into text data.

### Step S306

At step S306, the voice processing unit 153 stores the converted text data in the display text storage unit 132. That is, when the first input information 201S is detected, the voice input processing starts, and the text information corresponding to the voice of the user is sequentially stored in the display text storage unit 132.

### Step S307

When the input detection processing unit 151 detects the second input information 201E at step S307 (S307: YES), the procedure shifts to step S308. When the input detection processing unit 151 does not detect the second input information 201E (S307: NO), the procedure returns to step S301.

When the procedure returns to step S301, it is determined that the input detection processing unit 151 has already detected the first input information 201S (S301: YES), so that the procedure shifts to step S305. The voice processing unit 153 continuously converts the acquired voice data into text data (S305) and stores the converted text data in the display text storage unit 132 (S306). Thereby, text information corresponding to the voice of the user is stored in the display text storage unit 132 until the second input information 201E is detected (input).

### Step S308

At step S308, the voice processing unit 153 ends the voice input processing. As described above, the voice conversion processing is executed. The voice processing unit 153 stores, in the display text storage unit 132, the text data converted from the voice data during a period from when the first input information 201S is detected until the second input information 201E is detected.

Note that, text information corresponding to the text data stored in the display text storage unit 132 is displayed on the display unit 300 in accordance with an operation by the user (refer to [Text information display processing] (FIG. 6) according to Embodiment 1).

### Embodiment 3

An information processing system I according to Embodiment 3 further includes a configuration to display, on the display unit 300, information indicating that the voice input processing is being executed, in the information processing system 1 according to Embodiment 2. The information is, for example, information indicating that voice is being recognized.

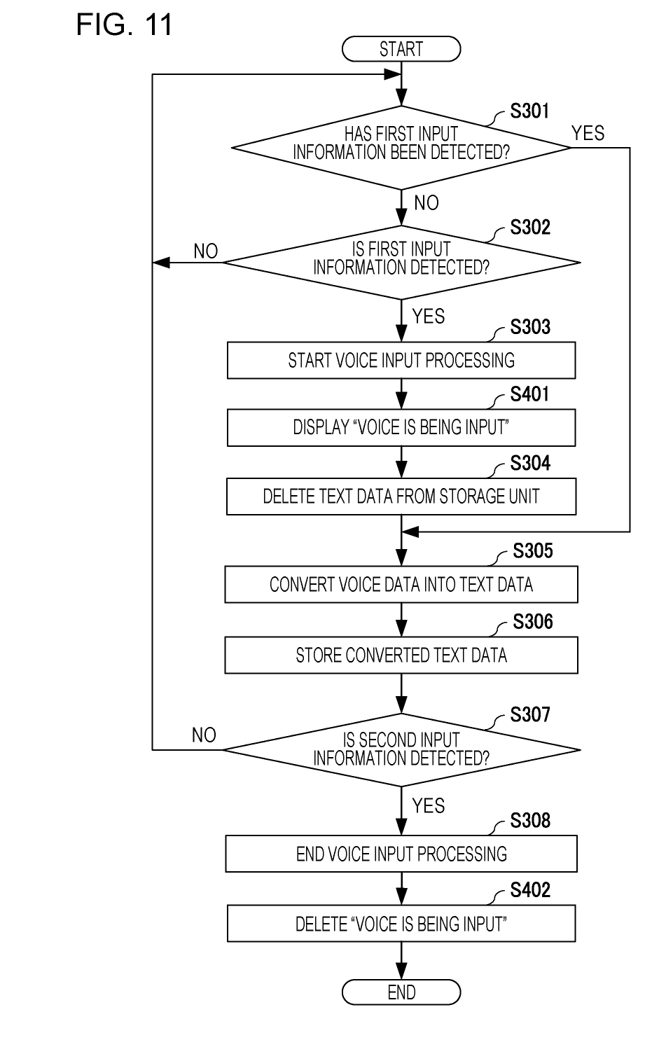

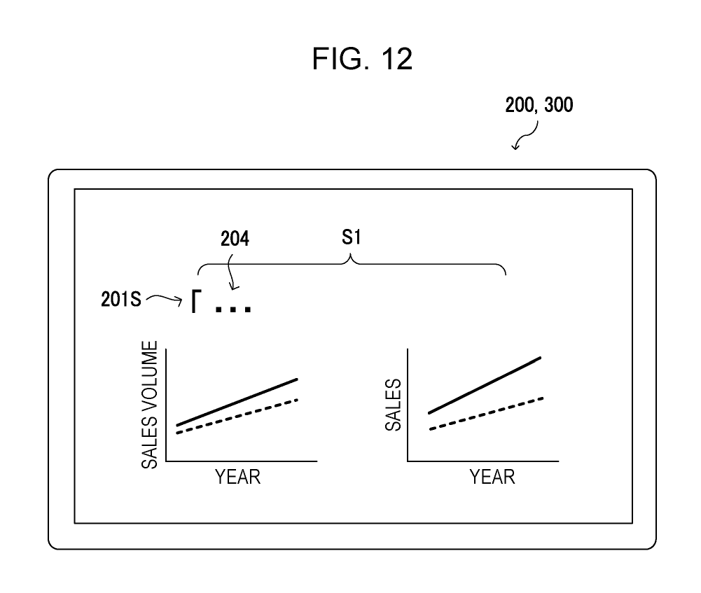

FIG. 11 is a flowchart illustrating an example of voice conversion processing according to Embodiment 3. Specifically, when the voice input, processing starts (S303), the display processing unit 156 causes the display unit 300 to display information 204 indicating that voice is being recognized (being input) in the region S1 as illustrated in FIG. 12 (S401). When the voice input processing ends (S308), the display processing unit 156 deletes the information 204 from the display unit 300 (S402).

Thereby, the user is able to recognize that text information corresponding to the voice is displayed on the display unit 300.

### Embodiment 4

An information processing system 1 according to Embodiment 4 further includes a configuration to end voice input processing when a predetermined operation by the user is detected while the voice input processing is being executed, in the information processing system 1 according to Embodiment 2. Examples of the predetermined operation include an operation of deleting the first input information 201S (for example, “┌”) by the user with use of an eraser tool on the touch panel 200, an operation of performing handwriting input in the region S1, and an operation of overwriting text information TX displayed in the region S1.

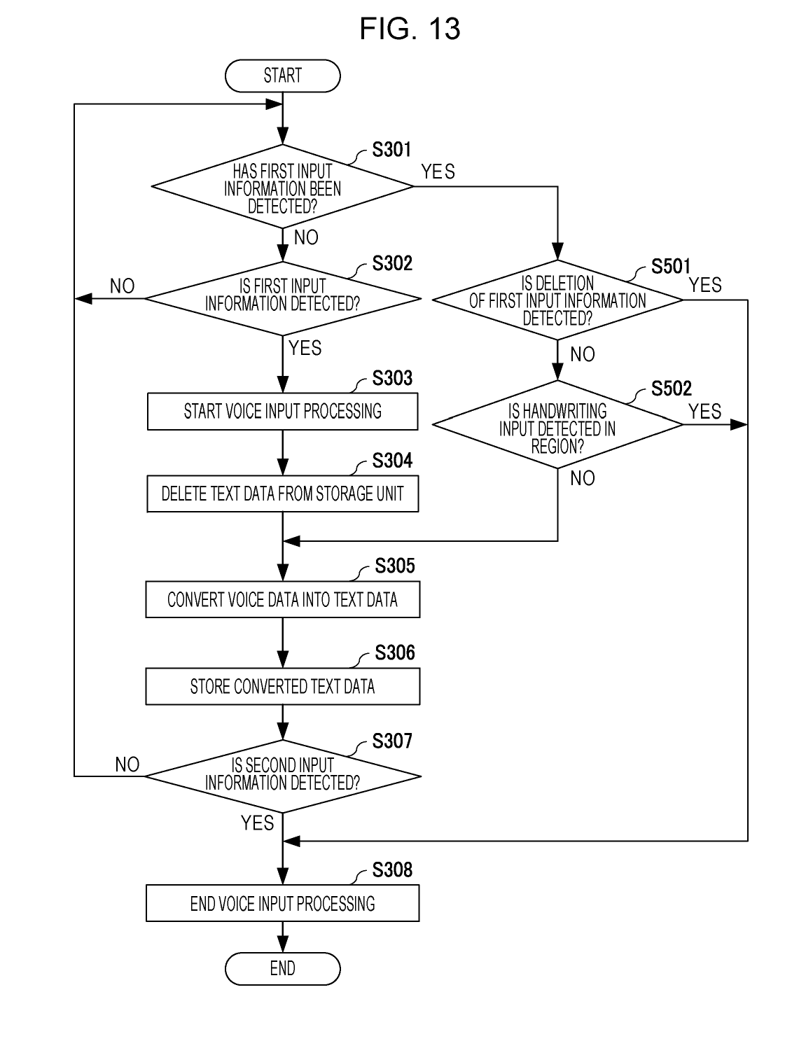

FIG. 13 is a flowchart illustrating an example of voice conversion processing according to Embodiment 4. In the flowchart illustrated in FIG. 13, steps S501 and S502 are further added to the flowchart illustrated in FIG. 10, for example.

Specifically, for example, the first input information 201S is detected, voice data is converted into text data, the converted text data is stored in the display text storage unit 132 (S301 to S306), and then, when the input detection processing unit 151 does not detect the second input information 201E (S307: NO), the procedure returns to step S301.

When the procedure returns to step S301, it is determined that the input detection processing unit 151 has already detected the first input information 201S (S301: YES), so that the procedure shifts to step S501. When the input detection processing unit 151 detects an operation of deleting the first input information 201S at step S501 (S501: YES), the voice processing unit 153 ends the voice input processing (S308). When the input detection processing unit 151 detects an operation of performing handwriting input in the region S1 at step S502 (S502: YES), the voice processing unit 153 ends the voice input processing (S308).

As a result, even when a mode of the voice input processing is provided without intention of the user, the user is able to immediately end the voice input processing by performing the predetermined operation. Note that, in the flowchart of FIG. 13, when the input detection processing unit 151 does not detect the operation of deleting the first input information 201S (S501: NO) and the input detection processing unit 151 does not detect the operation of performing handwriting input in the region S1 (S502: NO), the procedure shifts to step S305.

### Embodiment 5

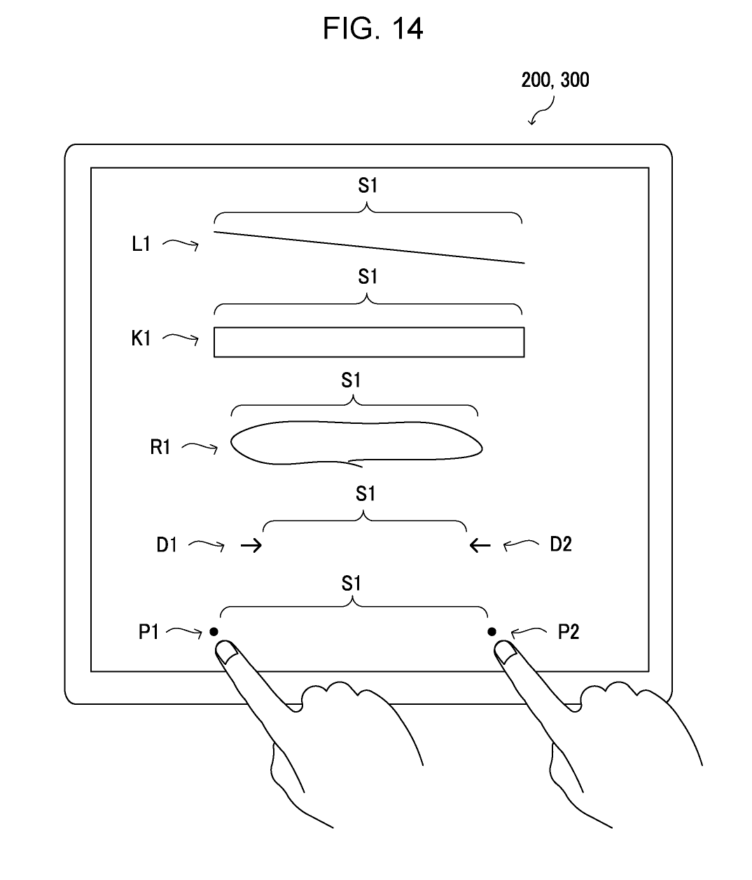

In each of the embodiments described above, predetermined input information (trigger information) that is set in advance is not limited to the marks “┌” and “┘”. As illustrated in FIG. 14, for example, the trigger information may be information of a straight line mark L1, a rectangular frame K1, a curve R1, or an arrow D1 or D2, or may be information P1 or P2 obtained by touching and inputting (designating) two points (two places) at the same time (or in a given time). In each of the trigger information, the first input information 201S is information at a left end and the second input information 201E is information at a right end. Thus, in each of the trigger information, a region between the first input information 201S (left end) and the second input information 201E (right end) serves as the region S1.

### Embodiment 6

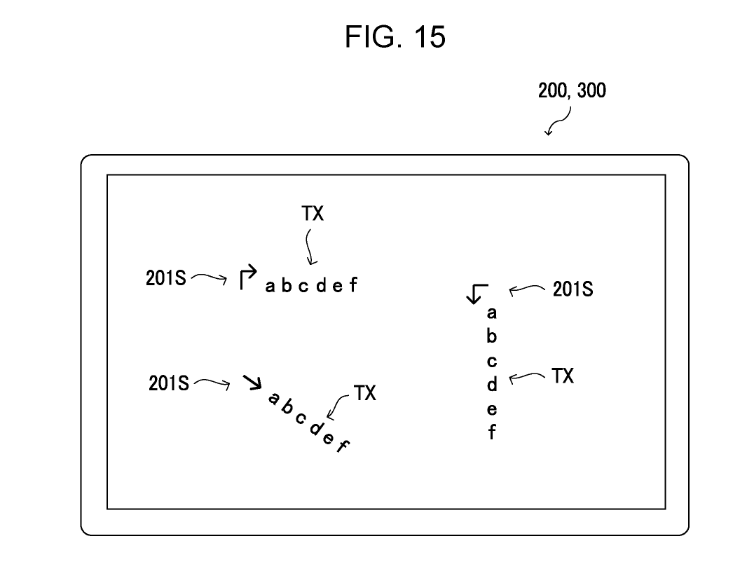

In each of the embodiments described above, at least any one of the first input information 201S and the second input information 201E may include display direction information indicating a direction in which the text information TX is displayed in the region S1. For example, as illustrated in FIG. 15, when the first input information 201S includes a horizontal arrow (display direction information), the display processing unit 156 causes the text information TX to be displayed in a horizontal direction. When the first input information 201S includes a vertical arrow (display direction information), the display processing unit 156 causes the text information TX to be displayed in a vertical direction. Further, when the first input information 201S includes an oblique arrow (display direction information), the display processing unit 156 causes the text information TX to be displayed in an oblique direction.

In each of the embodiments described above, information caused to be displayed in the region S1 is not limited to the text information TX obtained by converting voice data into a text format. For example, the information caused to be displayed in the region S1 may be input information when the user performs a predetermined input operation by using the operation unit 110. In this case, the display processing unit 156 causes the display unit 300 to display the input information, which is input with use of the operation unit 110 (for example, keyboard) by the user, on the basis of the input position information detected by the input detection processing unit 151.

The information caused to be displayed in the region S1 may be an image selected with use of the operation unit 110 (for example, mouse) by the user. In this case, the display processing unit 156 causes the display unit 300 to display the image, which is selected with use of the operation unit 110 by the user, on the basis of the input position information detected by the input detection processing unit 151.

Note that, in the information processing system 1 according to the disclosure, the information processing apparatus 100 may include the touch panel 200, the display unit 300, and the microphone 400. The information processing system 1 is not limited to an electronic blackboard system and is also applicable to a display apparatus with a touch panel, such as a PC (personal computer).

In the information processing system 1 according to the disclosure, a part of functions of the information processing apparatus 100 may be implemented by a server. Specifically, at least any one function of the input detection processing unit 151, the drawing processing unit 152, the voice processing unit 153, the region detection processing unit 154, the text processing unit 155, and the display processing unit 156 that are included in the control unit 150 of the information processing apparatus 100 may be implemented by the server.

For example, voice data acquired through the microphone 400 may be transmitted to the server, and the server may execute the processing of the voice processing unit 153, that is, processing of converting the voice data into text data. In this case, the information processing apparatus 100 receives the next data from the server. Moreover, for example, input information (touch information) to the touch panel 200 may be transmitted to the server and the server may execute the processing of the input detection processing unit 151, that is, processing of detecting the touched position and processing of storing information (input position information) of the touched position.

According to the configuration described above, for example, when a transmission destination terminal when the server transmits data (processing result) is set to a plurality of display apparatuses (for example, electronic blackboards), it is also possible to cause a content (text information) converted into a text to be displayed on the plurality of display apparatuses.

Note that, “predetermined information” (information displayed in the region S1) according to the disclosure is not limited to text information corresponding to voice of the user or an image selected with use of the operation unit 110 by the user. For example, the “predetermined information” may be translated text information. Specifically, the information processing apparatus 100 may convert voice by a statement of the user into text information and further perform translation processing for the text information and display resultant translation text information in the region S1.

For example, the “predetermined information” may be a search result by a search keyword on the Web. Specifically, the information processing apparatus 100 may convert voice by a statement of the user into text information and further perform keyword searching with the text information, and display a result (search result information ) thereof in the region S1. Note that, the “predetermined information” is not limited to information (such as text information, image information, or input information) corresponding to an action (statement, operation) by the user who inputs the first input information 201S and the second input information 201E and may be information corresponding to an action of a third party different from the user.

The information processing apparatus 100 may include a configuration to execute processing (command) corresponding to the “predetermined information” displayed in the region S1. For example, the information processing apparatus 100 may include a configuration to recognize “print” displayed in the region S1 as an operation command and start a print function.

The present disclosure contains subject matter related to that disclosed in Japanese Priority Patent Application JP 2018-034391 filed in the Japan Patent Office on Feb. 28, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising
a display processing unit that causes a display unit to display information based on a touch operation by a user to a touch panel, wherein
in a case where predetermined first input information and predetermined second input information that are set in advance are input by the touch operation of the user, the display processing unit causes predetermined information to be displayed on the display unit in a region between a position of the first input information and a position of the second input information.

2. The information processing apparatus according to claim 1, further comprising
a voice processing unit that converts voice data into text data, wherein
the display processing unit causes text information corresponding to the text data to be displayed in the region of the display unit.

3. The information processing apparatus according to claim 2, further comprising
a text processing unit that adjusts a display form of the text information to be displayed in the region to a display form corresponding to the region, wherein
the display processing unit causes the text information, the display form of which is adjusted by the text processing unit, to be displayed in the region.

4. The information processing apparatus according to claim 3, wherein
the text processing unit adjusts a size of a character that is the text information to be displayed in the region to a size corresponding to the region.

5. The information processing apparatus according to claim 2, wherein
the first input information includes display direction information indicating a direction in which the text information is displayed in the region, and
the display processing unit causes the display unit to display the text information, based on the display direction information.

6. The information processing apparatus according to claim 2, wherein
the display processing unit causes, the text information corresponding to the text data converted by the voice processing unit during a period from when the first input information is input until the second input information is input, to be displayed in the region.

7. The information processing apparatus according to claim 2, wherein
in a case where the first input information is input by the touch operation of the user, the display processing unit starts processing of the text information corresponding to the text data to be displayed on the display unit.

8. The information processing apparatus according to claim 7, wherein
in a case where the second input information is input by the touch operation of the user, the display processing unit ends the processing of the text information to be displayed on the display unit.

9. The information processing apparatus according to claim 2, wherein
the display processing unit performs first display processing of causing the display unit to display the text information corresponding to the text data and second display processing of causing the display unit to display handwritten information by the user to the touch panel, in parallel.

10. An information processing method comprising:
causing a display unit to display information based on a touch operation by a user to a touch panel; and
in a case where predetermined first input information and predetermined second input information that are set in advance are input by the touch operation of the user, causing predetermined information to be displayed on the display unit in a region between a position of the first input information and a position of the second input information.

11. A non-transitory storage medium storing a program causing a computer to execute:
causing a display unit to display information based on a touch operation by a user to a touch panel; and
in a case where predetermined first input information and predetermined second input information that are set in advance are input by the touch operation of the user, causing predetermined information to be displayed on the display unit in a region between a position of the first input information and a position of the second input information.
